(19) United States
(12) Patent Application Publication
(10) Pub. No.: US 2026/0169744 A1
(43) Pub. Date: Jun. 18, 2026

(54) SYSTEMS AND METHODS FOR INTERFERENCE ANALYSIS FOR LARGE LANGUAGE MODEL OUTPUTS

(71) Applicant: Red Hat, Inc., Raleigh, NC (US)

(72) Inventors: Leigh Griffin, Waterford (IE); Anthony Francis Carroll, Waterford (IE)

(21) Appl. No.: 18/986,281

(22) Filed: Dec. 18, 2024

(51) Int. Cl. G06F 9/30; G06F 9/50

(52) U.S. Cl. CPC G06F 9/30181; G06F 9/5016

(57) ABSTRACT

The present disclosure provides computer-implemented methods, systems, and devices for automatically analyzing interference within a system. A computing device obtains a request comprising a query. The computing device determine that the request satisfies an instructional credential. The computing device transmits, based on determining that the request satisfies the instructional credential, the query to a large language model (LLM). The computing device receives, from the LLM, an output comprising an instruction for a computer application. The computing device determines that the instruction further comprises an interference command. The interference command may be such that, in response to execution by the computer application, the command would result in an interference event. The computing device modifies, based on determining that the instruction comprises the interference command, the instruction by removing the interference command to generate a modified instruction.

### BACKGROUND

Computer systems frequently interact with large language models (LLMs). These interactions can frequently result in instructions provided by the LLM. The instructions may include operational instructions for the computer system. Deficiencies exist in existing technologies related to how computer systems interact with LLMs, and certain embodiments disclosed herein address these deficiencies.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method can be performed by a computing system comprising one or more processors. The one or more operations include steps for analyzing interference, such as interference commands and interference events. The operations include obtaining, by a computing system comprising one or more processor devices, a request comprising a query. The operations include determining, by the computing system, that the request satisfies an instructional credential. The operations include transmitting, based on determining that the request satisfies the instructional credential, the query to a large language model (LLM). The operations include receiving, from the LLM, an output comprising an instruction for a computer application. The operations include determining, by the computing system, that the instruction further includes an interference command, wherein the interference command, in response to execution by the computer application, would result in an interference event. The operations include modifying, based on determining that the instruction includes the interference command, the instruction by removing the interference command to generate a modified instruction.

Another example aspect of the present disclosure is directed to a computing system for analyzing interference, such as interference commands and interference events. The system can include one or more processors and one or more non-transitory computer-readable media that collectively store instructions that, when executed by the one or more processors, cause the computing system to perform operations. The one or more operations include steps for analyzing interference, such as interference commands and interference events. The operations include obtaining, by a computing system comprising one or more processor devices, a request comprising a query. The operations include determining, by the computing system, that the request satisfies an instructional credential. The operations include transmitting, based on determining that the request satisfies the instructional credential, the query to a large language model (LLM). The operations include receiving, from the LLM, an output comprising an instruction for a computer application. The operations include determining, by the computing system, that the instruction further includes an interference command, wherein the interference command, in response to execution by the computer application, would result in an interference event. The operations include modifying, based on determining that the instruction includes the interference command, the instruction by removing the interference command to generate a modified instruction.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 depicts an example computing device according to example embodiments of the present disclosure;

FIG. 2 depicts a block diagram of an example computing system for interference event detection when interacting with large language models (LLMs) according to example embodiments of the present disclosure;

FIG. 3 depicts an example interference analysis system in accordance with example embodiments of the present disclosure;

FIG. 4 is a flow diagram representing a process for automatically detecting interference events when interacting with LLMs in accordance with example embodiments of the present disclosure; and

FIG. 5 is a block diagram of a computing device suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

As used herein, the term “based on” is not meant to be restrictive, but rather indicates that a determination, identification, prediction, calculation, and/or the like, is performed by using, at least, the term following “based on” as an input. For example, predicting an outcome based on a particular piece of information may additionally, or alternatively, base the same determination on another piece of information. As used herein, the term “receive” or “receiving” means obtaining from a data repository (e.g., database), from another system or service, from a user via a user interface, from another software, or from another software component in a same software. In certain embodiments, the term “access” or “accessing” means retrieving data or information, and/or generating data or information.

Embodiments described herein are generally related to identifying or otherwise determining interference or potential interference events based on instructions or commands received from a large language model or other similar machine learning model. According to certain embodiments, a machine learning model can include training data (e.g., a part of training corpus) embedded in the model. In some embodiments, a generative AI (artificial intelligence) model includes training data embedded in the model. In certain embodiments, a generative AI model is a type of AI model that can be used to produce various type of content, such as text, images, videos, audio, 3D (three-dimensional) data, 3D models, and/or the like. In some embodiments, a language model or a large language model (LLM), which is a type of generative AI models, includes content and training data embedded in the model. In certain embodiments, a generative AI model may be subject to greater risk of allowing unauthorized access to data due to the training data embedded in the model.

In some embodiments, the machine learning model is a language model (“LM”) that may include an algorithm, rule, model, and/or other programmatic instructions that can predict the probability of a sequence of words. In some embodiments, a language model may, given a starting text string (e.g., one or more words), predict the next word in the sequence. In certain embodiments, a language model may calculate the probability of different word combinations based on the patterns learned during training (based on a set of text data from books, articles, websites, audio files, etc.). In some embodiments, a language model may generate many combinations of one or more next words (and/or sentences) that are coherent and contextually relevant. In certain embodiments, a language model can be an advanced artificial intelligence algorithm that has been trained to understand, generate, and manipulate language. In some embodiments, a language model can be useful for natural language processing, including receiving natural language prompts and providing natural language responses based on the text on which the model is trained. In certain embodiments, a language model may include an n-gram, exponential, positional, neural network, and/or other type of model.

In certain embodiments, the machine learning model is a large language model (LLM), which was trained on a larger data set and has a larger number of parameters (e.g., billions of parameters) compared to a regular language model. In certain embodiments, an LLM can understand more complex textual inputs and generate more coherent responses due to its extensive training. In certain embodiments, an LLM can use a transformer architecture that is a deep learning architecture using an attention mechanism (e.g., which inputs deserve more attention than others in certain cases). In some embodiments, a language model includes an autoregressive language model, such as a Generative Pretrained Transformer 3 (GPT-3) model, a GPT 3.5-turbo model, a Claude model, a command-xlang model, a bidirectional encoder representations from transformers (BERT) model, a pathways language model (PaLM) 2, and/or the like.

According to certain embodiments, a system may associate a data permission requirement with dataset (e.g., training corpus, training datasets). In some embodiments, the system may associate a model permission requirement with a machine learning model (e.g., a generative AI model). In certain embodiments, the system may associate a user permission requirement (e.g., a usage permission requirement) with a request to use a machine learning model. In some embodiments, a data permission requirement, a model permission requirement, and/or a user permission requirement (e.g., a usage permission requirement) includes a security level and/or an access level. In certain embodiments, a security level and an access level are collectively referred to as a permission level. In some embodiments, the security level can be one of a set of security levels (e.g., classified, unclassified, restricted, etc.).

According to some embodiments, the permission level, the security level (e.g., the security clearance level) and/or the access level can be hierarchical. In certain embodiments, a first permission level being higher than a second permission level refers to a model permission level and/or a usage permission level at the first permission level can access data of the first permission level and data of the second permission level. In some embodiments, a first permission level being higher than a second permission level refers to a model permission level and/or a usage permission level at the second permission level can access data of the second permission level but cannot access data of the first permission level.

In certain embodiments, a first security level being higher than a second security level refers to a model security level and/or a usage security level at the first security level can access data of the first security level and data of the second security level. In some embodiments, a first security level being higher than a second security level refers to a model security level and/or a usage security level at the second security level can access data of the second security level but cannot access data of the first security level.

In certain embodiments, a first access level being higher than a second access level refers to a model access level and/or a usage access level at the first access level can access data of the first access level and data of the second access level. In some embodiments, a first access level being higher than a second access level refers to a model access level and/or a usage access level at the second access level can access data of the second access level but cannot access data of the first access level. In certain embodiments, a first access level being parallel to a second access level refers to a model access level and/or a usage access level at the first access level can access data of the first access level but cannot access data of the second access level. In some embodiments, an access level includes allowing data access by a group of users. In certain embodiments, a first access level allows data access by a first group of users and a second access level allows data access by a second group of users.

Interference, as used herein, is a broad term that generally refers to any instruction or command that, if executed by a computing system, would result in an underperformance of a system relative to an expectation or standard. Interference may be synonymous with interference command in certain circumstances. An interference event relates to a result of execution of the interference or interference command/instruction.

In many circumstances, a computing system interacts with an LLM or other machine learning model. The model may receive a prompt from the computing system and, in turn, provide a response or output. The output of the model may include one or more instructions related to the computing system and/or a separate computing device. For example, the computing system may be in the context of an automobile, and the model's response may include instructions and/or commands related to execution of one or more computer programs by the automobile's electronic processor(s). Interference may result, for example, if the computing (e.g., processing, memory, routing, network, etc.) resources of the automobile's electronic processor(s) become reduced, slowed, or otherwise inhibited below a threshold. In some cases, a resulting interference event may result in a failure of one or more components of the automobile and/or of associated computing devices. Accordingly, it can be beneficial to avoid interference events that may otherwise result from interactions with a model (e.g., an LLM).

Generally, the present disclosure is directed towards a system for analyzing, identifying, and/or preventing interference events. To do so, a computing system can determine that a request (e.g., from a computing device, from a user) satisfies an instructional credential (e.g., the request and/or the requestor have sufficient authority). The computing system can transmit the request to a model, such as a machine learning model (e.g., an LLM) and receive a resulting output. The computing system can identify an instruction associated with a computer application. The computer application may be related to a computing environment in which the model and/or the computing system are located. As noted above, such a computing environment can include an automobile, a healthcare system, and/or any other computing environment in which computing resources may be scarce, in high-demand, and/or otherwise limited and/or in which interactions with a computing model may be necessary.

The computing system may determine that the response from the computing model includes one or more instructions that include an interference command, which would result or likely result in an interference event if executed by the computing system or by any other computing device within the computing environment.

For example, a user in an automobile may wish to execute certain media via a user interface. The user's request may be received by the computing system and passed to an LLM (e.g., after determining that the user is properly authorized to control associated media applications and/or that use of the media application is authorized by standards coded into the computing system.

The LLM may respond with an instruction to execute the media via a particular media application (e.g., movie application, game application, etc.). The computing system may determine that the instruction to execute the media via the media application (e.g., by causing the media application to boot up) would exceed a processing and/or memory threshold of the automobile's computing environment (e.g., may cause another application of the computing environment to fail to properly control the automobile's steering system). The computing system may modify the model's response to avoid causing the media application to exceed the processing and/or memory threshold of the automobile's computing environment. This may be accomplished, for example, by modifying the instruction received by the model, such as by removing the instruction to boot up the media application in the first place and/or by causing the media application to boot up in a lower-resource mode.

More particularly, an interference analysis system can obtain a request that includes a query. The system can determine that the request satisfies an instructional credential and transmit, based on determining that the request satisfies the instructional credential, the query to a large language model (LLM). The interference analysis system can receive, from the LLM, an output that includes an instruction for a computer application (e.g., a media application). The interference analysis system can determine that the instruction also includes an interference command that, if executed by the computer application, would result in an interference event. The interference event can include an insufficient amount of memory resources available to one or more of the computing device, the computer application, the LLM, a separate computing device (e.g., one having memory resources that are at least partially dependent on the amount of resources allocated to the computer application), and/or some other computing device. The interference analysis system can modify the instruction to remove the interference command, based on determining that the instruction comprises the interference command.

In some examples, the system can transmit the modified instruction to the computer application. When the system determines that the request satisfies the instructional credential, this could include determining that the computing device includes an authorization credential configured to allow modification of the instruction. Additionally or alternatively, determining that the request satisfies the instructional credential can include determining that a recipient (e.g., ultimate recipient) of the request is included on a list of authorized agents (e.g., for providing instructions to the computer application). The system may determine that the instruction would allocate processing resources away from or toward the computer application. The allocated processing resources may be outside (e.g., above) a threshold range of processing resources. In some examples, the system may generate an alert that indicates that the instruction was modified.

The systems and methods of the present disclosure provide a number of technical effects and benefits. As one example, the systems and methods can prevent or reduce an incidence of failure of certain components of a computer environment. For example, the systems and methods may prevent an overtaxing of computing resources of critical infrastructure in response to instructions from a computer model. Thus, the systems and methods described herein may prevent injury or even death due to failure of certain components (e.g., mechanical components) that may be controlled by and/or within the computing environment. Additionally or alternatively, the systems and methods described herein may reduce the amount of memory needed and power used at a particular computing system by offloading, rerouting, and/or otherwise modifying computation-intensive portions of one or more computing devices within the computing environment. Doing so can allow enhanced processing of commands/instructions from a computer model, significantly reducing the time and cost needed to evaluate computation-intensive instructions from the computer model.

With reference now to the Figures, example embodiments of the present disclosure will be discussed in further detail.

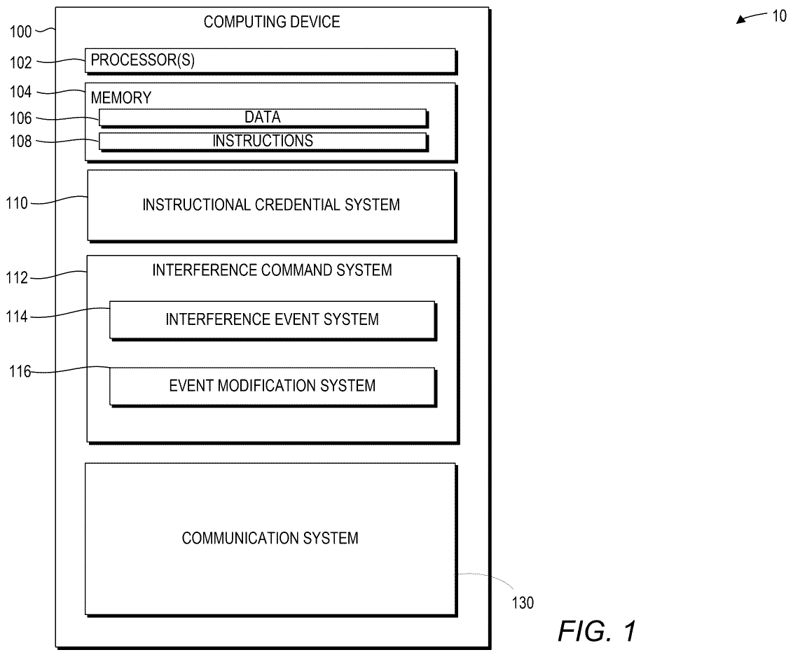

FIG. 1 depicts an example computing device 100 according to example embodiments of the present disclosure. In some example embodiments, the computing device 102 can be any suitable device, including, but not limited to a desktop computer, a tablet, a laptop, server computing system, or any other computer device that is able to perform the methods described herein. The computing device 100 can include one or more processor(s) 102, memory 104, instructional credential system 110, an interference command system 112, and a communication system 130. The computing device 100 can be one of many devices within a computing environment 10.

The one or more processor(s) 102 can be any suitable processing device, such as a microprocessor, microcontroller, integrated circuit, or other suitable processing device. The memory 104 can include any suitable computing system or media, including, but not limited to, non-transitory computer-readable media, RAM, ROM, hard drives, flash drives, or other memory devices. The memory 104 can store information accessible by the one or more processor(s) 102, including instructions 108 that can be executed by the one or more processor(s) 102. The instructions can be any set of instructions that when executed by the one or more processor(s) 102, cause the one or more processor(s) 102 to provide the desired functionality.

In particular, in some devices, memory 104 can store instructions for implementing the instructional credential system 110, the interference command system 112, the interference event system 114, and the event modification system 116. The computing device 102 can implement the instructional credential system 110, the interference command system 112, the interference event system 114, and the event modification system 116 to execute aspects of the present disclosure, including automatically partitioning a directed graph of nodes, generating containers for the partitions, and processing input using the directed graph of nodes and its associated partitions.

It will be appreciated that the terms “system” or “engine” can refer to specialized hardware, computer logic that executes on a more general processor, or some combination thereof. Thus, a system or engine can be implemented in hardware, application-specific circuits, firmware, and/or software controlling a general-purpose processor. In one embodiment, the systems can be implemented as program code files stored on a storage device, loaded into memory and executed by a processor or can be provided from computer program products, for example computer executable instructions, that are stored in a tangible computer-readable storage medium such as RAM, hard disk, or optical or magnetic media.

Memory 104 can also include data 106, such as the data described herein 110, that can be retrieved, manipulated, created, or stored by the one or more processor(s) 102. In some example embodiments, such data can be accessed and displayed to a user of the computing device 100 or transmitted to a remote computing system as needed.

In some example embodiments, the computing device 100 includes the instructional credential system 110, the interference command system 112, the interference event system 114, and the event modification system 116, and the communication system 130. The computing device 100 can store instructions for executing commands for and/or otherwise controlling the instructional credential system 110, the interference command system 112, the interference event system 114, and the event modification system 116, and the communication system 130, such as described herein.

The instructional credential system 110 can analyze credentials needed for obtaining access to, responses from, and/or authorization to execute instructions related to one or more computer applications within the computing environment 10. The instructional credential system 110 can help ensure that communication system 130, which may be an API, has the proper credentials and/or intentions, thus safeguarding the integrity, privacy, and/or functionality of the computing device 100. The processor(s) 102 can validate one or more credentials associated with an API request received by and/or transmitted via the communication system 130. This may include verifying authentication tokens, keys, and/or certificates against a trusted database. For example, if the communication system 130 requests information about a car's speed or tire pressure, the computing device 100 may confirm that the communication system 130 belongs to an authorized entity, such as the vehicle's manufacturer, service provider, and/or a certified third-party application. Credential verification can prevent or reduce an incidence of unauthorized entities from accessing data and/or performing potentially harmful actions.

In some examples, the instructional credential system 110 can determine an intention behind the API request. The instructional credential system 110 can analyze the requested operations, such as retrieving specific data, modifying parameters, and/or deleting resources. For example, if the request includes instructions to delete a vehicle's configuration settings and/or to use an amount of computing resources for one or more vehicle systems in the computing environment 10, the instructional credential system 110 can flag this as a high-risk operation and/or may require additional verification steps. The instructional credential system 110 can track historical usage patterns to help detect unusual and/or potentially malicious behavior, such as repeated access attempts targeting sensitive operations and/or high-resource requests.

The instructional credential system 110 may determine whether the received request aligns with the state of the computing device 100. For example, if the computing device 100 (e.g., via the communication system 130) reports that it is raining and attempts to instruct a specific response (e.g., activating windshield wipers and/or altering driving parameters), the instructional credential system 110 may cross-reference this claim with data from the car's internal sensors. The instructional credential system 110 may identify discrepancies between external and internal data, such as misinformation or deliberate manipulation. In some embodiments, the instructional credential system 110 can detect and/or mitigate potential misuse or abuse. For example, the instructional credential system 110 may determine that excessive requests may be designed to overload the system (e.g., denial-of-service attacks) and/or that the request includes one or more misleading commands that attempt to override safety protocols. The instructional credential system 110 can execute rate-limiting and/or anomaly detection algorithms to identify and/or remove such threats. Continuing in the example above, if a request frequently attempts to modify safety-critical parameters like braking systems, the system can temporarily suspend access to requests related to the braking system. In some embodiments, the instructional credential system 110 may cause an alert to be generated.

The interference command system 112 can determine that an instruction of a request further comprises an interference command, wherein the interference command, in response to execution by the computer application, would result in an interference event. The interference command system 112 can include the interference event system 114 and/or the event modification system 116. The interference event system 114 may determine that the interference command would result in an interference event. Additionally or alternatively, the interference event system 114 may determine an extent or severity of interference from execution of the interference command by the computing device 100. The event modification system 116 can modify one or more instructions from an LLM's response to prevent interference. For example, the event modification system 116 may remove any commands from the response that may cause an interference event.

The interference command system 112 can communicate with a large language model (LLM). Additionally or alternatively, the interference command system 112 may include standards for computational resources, such as functional safety (FuSa) standards in automotive systems described herein. The interference command system 112 can identify a trigger or other interference command in the response from the LLM. The interference event can include a command or request that would require computational resources (e.g., memory, processing power, network bandwidth, etc.) beyond safe operational thresholds (e.g., according to FuSa standards). In some embodiments, the interference command system 112 is also governed by other safety standards such as Automotive Safety Integrity Levels (ASIL).

The FuSa or other safety standards can define operational constraints, including thresholds for memory usage, allowable computational cycles, and/or acceptable network bandwidth consumption. For example, if the LLM recommends activating a high-resolution sensor network and processing its data in real time, the interference command system 112 evaluates whether the instructions from a response from the LLM would exceed an available resources, which can lead to memory collisions with other processes. By detecting such conflicts before execution of the LLM's recommendations, the interference command system 112 can prevent unsafe scenarios and help ensure that the decision-making processes of the computing device 100 align with the computing environment's 10 (e.g., vehicle's) safety-critical operational standards.

The interference command system 112 can include a dynamic API decoration, which can tag APIs with metadata indicating their expected ASIL compliance level. This metadata can allow the LLM to scope its recommendations within the bounds of the system's security and safety requirements. For example, if the LLM's response includes an instruction that requires ASIL D compliance (a stringent safety level) but the component it interacts with is only certified for ASIL B, the interference command system 112 (e.g., the interference event system 114, the event modification system 116) the interference event system 114) can adjust the parameters of the request and/or deny its execution.

The interference command system 112 may take into account factors such as geolocation, data quality, and/or trustworthiness when determining whether and/or how to modify the LLM's response. For example, in high-risk environments such as urban traffic or adverse weather conditions, the interference command system 112 may impose stricter constraints on the LLM's recommendations to prevent potential interference events, even if under normal circumstances the instruction from the LLM may otherwise be satisfactory. Additionally or alternatively, in some embodiments, in lower-risk scenarios, the interference command system 112 can afford greater flexibility, allowing the LLM to improve performance within broader operational constraints.

The interference command system 112 can detect a potential interference event and employ mitigation strategies, such as modifying the LLM's output or altering the computational resources allocated to the response. For example, if a recommendation requires an intensive computation that could overload the system, the computing framework might reduce the resolution or scope of the task to fit within safe parameters. In some cases, the system may defer certain non-critical operations to ensure real-time safety-critical processes remain unaffected. This layered approach ensures that safety and efficiency are not compromised by the LLM's operation.

The communication system 130 may be configured to receive and/or transmit data between the computing device 100 and other computing devices. For example, the communication system 130 may interact with the LLM, a computer application, and/or other computing devices in the computing environment 10.

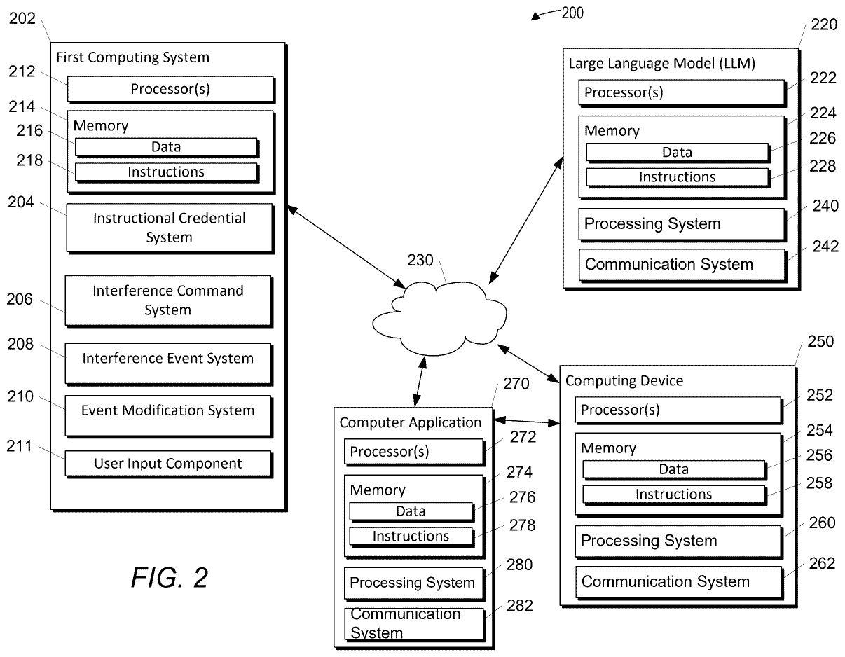

FIG. 2 depicts a block diagram of an example computing system 200 for interference event detection when interacting with large language models (LLMs) according to example embodiments of the present disclosure. The computing system 200 includes a first computing system 202 and/or one or more remote computing systems that are communicatively coupled over a network 230. The various computing elements of the computing system 200 can communicate with each other via a direct connection in some embodiments. For example, one or more of the elements of the computing system 200 may be disposed within an automobile system in some embodiments.

The first computing system 202 can be any type of computing device, such as a personal computing device (e.g., laptop or desktop), a server computing device, a tablet computer, an embedded computing device, or any other type of computing device.

The first computing system 202 includes one or more processors 212 and a memory 214. The one or more processors 212 can be any suitable processing device (e.g., a processor core, a microprocessor, an ASIC, an FPGA, a controller, a microcontroller, etc.) and can be one processor or a plurality of processors that are operatively connected. The memory 214 can include one or more non-transitory computer-readable storage mediums, such as RAM, ROM, EEPROM, EPROM, flash memory devices, magnetic disks, etc., and combinations thereof. The memory 214 can store data 216 and instructions 218, which are executed by the processor 212 to cause the first computing system to perform operations.

The first computing system 202 can also include one or more user input components 211 that receive user input. For example, the user input component 211 can be keyboard or a mouse. The input component 211 can include a touch-sensitive component (e.g., a touch-sensitive display screen or a touchpad) that is sensitive to the touch of a user input object (e.g., a finger or a stylus). The touch-sensitive component can serve to implement a virtual keyboard. Other example user input components 211 include a microphone, or other means by which a user can provide user input.

In some implementations, the first computing system 202 can store the instructional credential system 204, the interference command system 206, the interference event system 208, and/or the event modification system 210 to execute aspects of the present disclosure, including automatically determining interference instructions and modifying the interference instructions.

As discussed above, the large language model 220 can receive a query from the first computing system 202. The query may be a portion of a request received by the 202. Additionally or alternatively, the large language model 220 can provide a response to the query. The response may include one or more instructions/commands for the computer application 270 and/or for another computing device of the computing system 200. The large language model 220 may, in some embodiments, include its own processor(s) 222, memory 224 (which may include the trained data 226 and/or instructions 228 thereon), a processing system 240, and a communication system 242. The communication system 242 may include an API and/or some other electronic and/or hardware communication elements. For example, the communication system 242 may include a wired and/or wireless data interface.

The computer application 270 can include one or more applications that may be part of the computing system 200 and/or part of the computing environment 10. The computer applications can include one or more processor(s)272, a memory 274, a processing system 280, and/or a communication system 282. The memory 274 can include data 276 and instructions 278 for executing and operating the computer application. The computer application 270 may include any application that may be accessible to any computing system (e.g., the first computing system 202, the large language model 220, the computing device 250) of the computing system 200. The computer application 270 may include, for example, media applications, logic applications, navigations applications, control applications, systems applications (e.g., for a system of a machine such as an automobile), and/or other electronic applications.

The computing device 250 can include one or more computing devices that may perform one or more operations described herein. The computing device 250 can include a central computing system of a mechanical system, such as an automobile. The computing device 250 may be configured to control operation of one or more systems of the mechanical system and/or have access to communication with one or more of the other computing systems (e.g., the first computing system 202, the large language model 220) of the computing system 200. The computing device 250 may execute instructions provided to it from the first computing system 202.

The computing device 250 may in some embodiments be remote from the other elements of the computing system 200. The computing device 250 may include one or more processors 252 and memory 254. The one or more processors 252 can be any suitable processing device (e.g., a processor core, a microprocessor, an ASIC, an FPGA, a controller, a microcontroller, etc.) and can be one processor or a plurality of processors that are operatively connected. The memory 254 can include one or more non-transitory computer-readable storage mediums, such as RAM, ROM, EEPROM, EPROM, flash memory devices, magnetic disks, etc., and combinations thereof. The memory 254 can store data 256 and instructions 258 which are executed by the processor(s) 252 to cause the computing device 250 to perform operations.

In some implementations, the computing device 250 includes or are otherwise implemented by one or more server computing devices. In instances in which computing device 250 includes plural server computing devices, such server computing devices can operate according to sequential computing architectures, parallel computing architectures, or some combination thereof. As described above, the large language model 220 can store or otherwise include a processing system 260 and a communication system 262.

The network 230 can be any type of communications network, such as a local area network (e.g., intranet), wide area network (e.g., Internet), or some combination thereof and can include any number of wired or wireless links. In general, communication over the network 230 can be carried via any wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

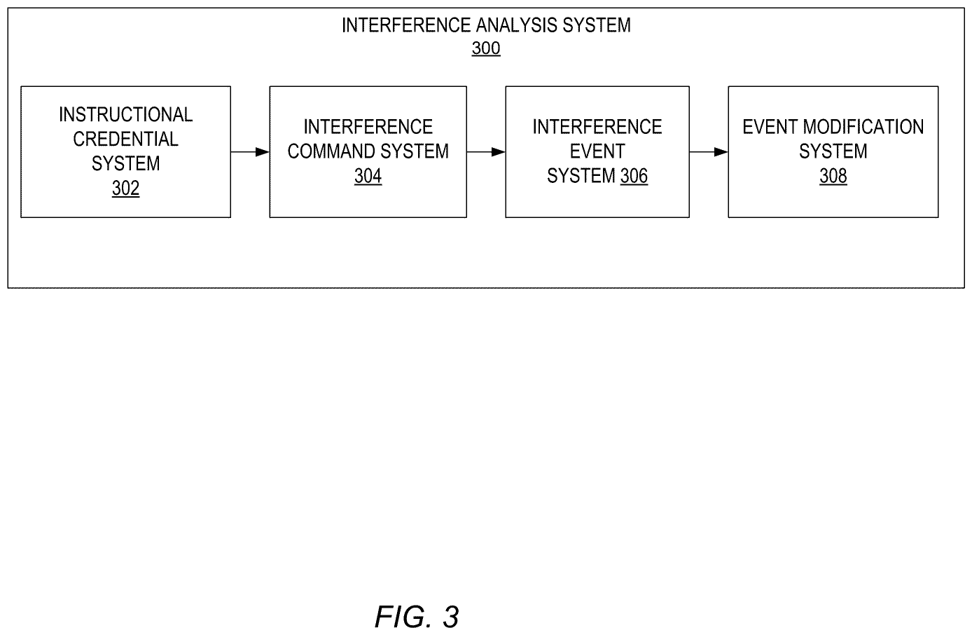

FIG. 3 depicts an example interference analysis system 300 in accordance with example embodiments of the present disclosure. The interference analysis system 300 can include an instructional credential system 302, an interference command system 304, an interference event system 306, and/or an event modification system 308.

Instructional credential system 302 can analyze credentials needed for obtaining access to, responses from, and/or authorization to execute instructions related to one or more computer applications described herein. The instructional credential system 302 can help ensure that any associated communication system, such as those described herein, has the proper credentials and/or intentions. This may include verifying authentication tokens, keys, and/or certificates against a trusted database. Credential verification can prevent or reduce an incidence of unauthorized entities from accessing data and/or performing potentially harmful actions.

In some examples, the instructional credential system 302 can determine an intention behind, for example, an API request. The instructional credential system 302 can analyze the requested operations, such as retrieving specific data, modifying parameters, and/or deleting resources. The instructional credential system 302 can flag improper instructions as a high-risk operation and/or may require additional verification steps. The instructional credential system 302 can track historical usage patterns to help detect unusual and/or potentially malicious behavior, such as repeated access attempts targeting sensitive operations and/or high-resource requests.

The instructional credential system 302 may determine whether a received request aligns with one or more standards, such as those stored on the interference analysis system 300. For example, the instructional credential system 302 may cross-reference known circumstances with data and/or instructions received from a model, such as an LLM. The instructional credential system 302 may identify discrepancies between external and internal data, such as misinformation or deliberate manipulation. In some embodiments, the instructional credential system 302 can detect and/or mitigate potential misuse or abuse.

Once the instructional credential system 302 has performed its operations, the model's response (e.g., from the LLM) can be provided to the interference command system 304. The interference command system 304 can determine that an instruction of the model's request includes an interference command. The interference event system 306 may determine that the interference command would result in an interference event. Additionally or alternatively, the interference event system 306 may determine an extent or severity of interference from execution of the interference command 0.

After the interference event system 306 has identified an interference event, the event modification system 308 can modify one or more instructions from the model's response to prevent interference. For example, the event modification system 308 may remove any commands from the response that may cause an interference event.

For example, the interference event can include a command or request that would require computational resources (e.g., memory, processing power, network bandwidth, etc.) beyond a threshold range of resources, such as a threshold range of safe operational thresholds (e.g., according to FuSa standards).

Various safety standards stored by the interference analysis system 300 can define operational constraints, including thresholds for memory usage, allowable computational cycles, and/or acceptable network bandwidth consumption. The interference analysis system 300 can evaluate whether the instructions from a response from the LLM would exceed an available resources, which can lead to memory collisions with other processes. By detecting such conflicts before execution of the LLM's recommendations, the interference command system 304 can prevent unsafe scenarios and help ensure that the decision-making processes of the interference analysis system 300 align with appropriate operational standards.

One or more elements of the interference analysis system 300 (e.g., the interference command system 304, the event modification system 308) may take into account factors such as geolocation, data quality, and/or trustworthiness of a source of a request when determining whether and/or how to modify the LLM's response. The event modification system 308 can detect a potential interference event and employ mitigation strategies, such as modifying the LLM's output or altering the computational resources allocated to the response.

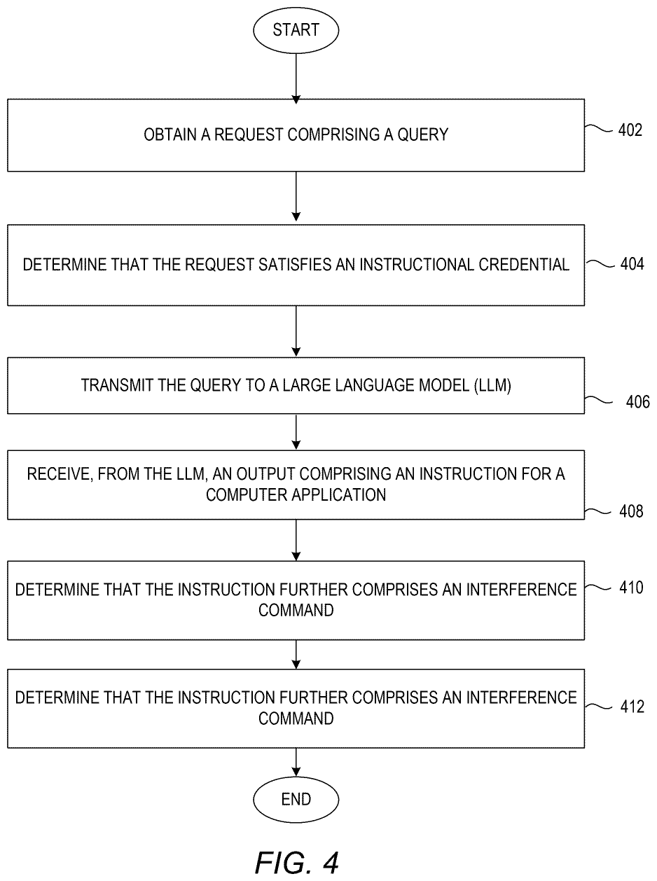

FIG. 4 is a flow diagram representing a process for automatically detecting interference events when interacting with LLMs in accordance with example embodiments of the present disclosure. The process can be performed by a computing system. The computing system can comprise one or more processors and one or more non-transitory computer-readable media that store instructions. The computing system can include an interference analysis system. The interference analysis system can, at 402, obtain a request comprising a query.

The interference analysis system can, at 404, determine that the request satisfies an instructional credential. In some examples, the interference analysis system can determine that the computing device comprises an authorization credential configured to allow modification of the instruction. The interference analysis system can, at 406, transmit, based on determining that the request satisfies the instructional credential, the query to a large language model (LLM). The interference analysis system can, at 408, receive, from the LLM, an output comprising an instruction for a computer application.

The interference analysis system can, at 410, determine that the instruction further comprises an interference command, wherein the interference command, in response to execution by the computer application, would result in an interference event. For example, the interference analysis system can determine that the instruction would allocate processing resources away from or toward the computer application. Additionally or alternatively, the interference event comprises an amount of processing resources allocated to the computer application that are outside a threshold range of processing resources. The interference event can include an insufficient amount of memory resources available to at least one of: the computing device, the computer application, the LLM, a second computing device having memory resources at least partially dependent on the amount of resources allocated to the computer application. The second computing system may have computing resources that are at least partially dependent on an amount of computing resources allocated to the computer application. These dependent computer resources may be allocated in an amount below a threshold amount. If the resources are below the threshold amount, the interference analysis system may fail to execute the instruction and/or forbid the computer application from executing the instruction.

The interference analysis system can, at 412, modify, based on determining that the instruction comprises the interference command, the instruction by removing the interference command to generate a modified instruction. In some embodiments, the interference analysis system can transmit the modified instruction to the computer application.

In some examples, the interference analysis system can generate, based on removing the interference command, an alert comprising an indication that the instruction was modified. Additionally or alternatively, the interference analysis system may generate, based on removing the interference command, an alert comprising an indication that the instruction was modified.

In some examples, the interference command can include modify the instruction by failing to transmit the modified instruction to the computer application.

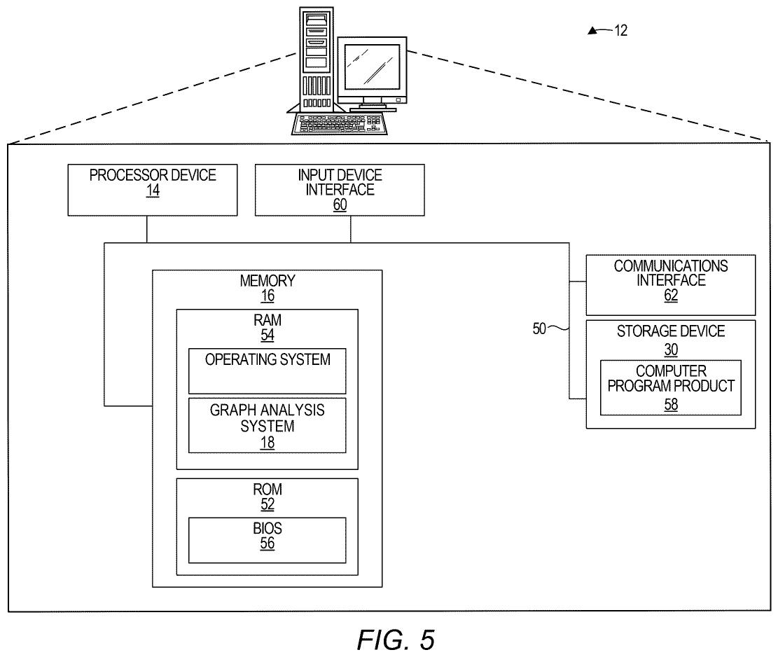

FIG. 5 is a block diagram of the computing device 12 suitable for implementing examples according to one example. The computing device 12 may comprise any computing or electronic device capable of including firmware, hardware, and/or executing software instructions to implement the functionality described herein, such as a computer server, a desktop computing device, a laptop computing device, or the like. The computing device 12 includes the processor device 14, the system memory 16, and a system bus 50. The system bus 50 provides an interface for system components including, but not limited to, the system memory 16 and the processor device 14. The processor device 14 can be any commercially available or proprietary processor device.

The system bus 50 may be any of several types of bus structures that may further interconnect to a memory bus (with or without a memory controller), a peripheral bus, and/or a local bus using any of a variety of commercially available bus architectures. The system memory 16 may include non-volatile memory 52 (e.g., read-only memory (ROM), erasable programmable read-only memory (EPROM), electrically erasable programmable read-only memory (EEPROM), etc.), and volatile memory 54 (e.g., random-access memory (RAM)). A basic input/output system (BIOS) 56 may be stored in the non-volatile memory 52 and can include the basic routines that help to transfer information between elements within the computing device 12. The volatile memory 54 may also include a high-speed RAM, such as static RAM, for caching data.

The computing device 12 may further include or be coupled to a non-transitory computer-readable storage medium such as the storage device 20, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 30 and other drives associated with computer-readable media and computer-usable media may provide non-volatile storage of data, data structures, computer-executable instructions, and the like.

A number of modules can be stored in the storage device 30 and in the volatile memory (e.g., RAM 54), including an operating system and one or more program modules, such as the graph analysis system 18, which may implement the functionality described herein in whole or in part. All or a portion of the examples may be implemented as a computer program product 58 stored on a transitory or non-transitory computer-usable or computer-readable storage medium, such as the storage device 30, which includes complex programming instructions, such as complex computer-readable program code, to cause the processor device 14 to carry out the steps described herein. Thus, the computer-readable program code can comprise software instructions for implementing the functionality of the examples described herein when executed on the processor device 14. The processor device 14, in conjunction with the graph analysis system 18 in the volatile memory 54, may serve as a controller, or control system, for the computing device 12 that is to implement the functionality described herein.

An operator may also be able to enter one or more configuration commands through a keyboard (not illustrated), a pointing device such as a mouse (not illustrated), or a touch-sensitive surface such as a display device. Such input devices may be connected to the processor device 14 through an input device interface 60 that is coupled to the system bus 50 but can be connected by other interfaces such as a parallel port, an Institute of Electrical and Electronic Engineers (IEEE) 1394 serial port, a Universal Serial Bus (USB) port, an IR interface, and the like. The computing device 12 may also include a communications interface 62 suitable for communicating with a network as appropriate or desired.

Individuals will recognize improvements and modifications to the preferred examples of the disclosure. All such improvements and modifications are considered within the scope of the concepts disclosed herein and the claims that follow.

1. A method, comprising:
obtaining, by a computing system comprising one or more processor devices, a request comprising a query for a large language model (LLM) to generate an instruction for execution by a computer application;
determining, by the computing system, that the request satisfies an instructional credential that verifies whether the instruction is to be executed by the computer application;
transmitting, based on determining that the request satisfies the instructional credential, the query to the LLM;
receiving, from the LLM, an output comprising the instruction for the computer application;
determining, by the computing system, that the instruction further comprises an interference command, wherein the interference command, in response to execution by the computer application, would result in an interference event, wherein determining that the instruction comprises the interference command comprises:
evaluating the instruction in view of an operational constraint for the computer application; and
identifying the interference command within the instruction based on evaluating the instruction in view of the operational constraint;
modifying, based on determining that the instruction comprises the interference command, the instruction by removing the interference command to generate a modified instruction; and
causing, by the computing system, execution of the modified instruction by the computer application.

2. The method of claim 1, wherein causing execution of the modified instruction comprises:
transmitting, by the computing system, the modified instruction to the computer application.

3. The method of claim 1, wherein determining that the request satisfies the instructional credential comprises determining that the computing system comprises an authorization credential configured to allow modification of the instruction.

4. The method of claim 1, wherein determining that the request satisfies the instructional credential comprises determining that a list of authorized agents for providing instructions to the computer application comprises at least one of: the LLM or the computing system.

5. The method of claim 1, wherein determining that the instruction comprises the interference command comprises determining that the instruction would allocate memory resources away from or toward the computer application.

6. The method of claim 1, wherein the interference event comprises an insufficient amount of memory resources available to at least one of: the computing system, the computer application, the LLM, a second computing system having memory resources at least partially dependent on an amount of resources allocated to the computer application.

7. The method of claim 1, wherein determining that the instruction comprises the interference command comprises determining that the instruction would allocate processing resources away from or toward the computer application.

8. The method of claim 7, wherein the interference event comprises an amount of processing resources allocated to the computer application that are outside a threshold range of processing resources.

9. The method of claim 1, wherein determining that the instruction comprises the interference command comprises determining that a second computing system having computing resources at least partially dependent on an amount of computing resources allocated to the computer application would be allocated an amount of computing resources below a threshold amount.

10. (canceled)

11. The method of claim 1, further comprising:
generating, based on removing the interference command, an alert comprising an indication that the instruction was modified.

12. The method of claim 1, wherein obtaining the request comprises receiving the request via a user interface.

13. A computing device, comprising:
a memory; and
a processor device coupled to the memory to:
obtain a request comprising a query for a large language model (LLM) to generate an instruction for execution by a computer application;
determine that the request satisfies an instructional credential that determines whether the instruction is to be executed by the computer application;
transmit, based on determining that the request satisfies the instructional credential, the query to the LLM;
receive, from the LLM, an output comprising the instruction for the computer application;
determine that the instruction further comprises an interference command, wherein the interference command, in response to execution by the computer application, would result in an interference event, wherein, to determine that the instruction comprises the interference command, the processor device is further to:
evaluate the instruction in view of an operational constraint for the computer application; and
identify the interference command within the instruction based on evaluating the instruction in view of the operational constraint;
modify, based on determining that the instruction comprises the interference command, the instruction by removing the interference command to generate a modified instruction; and
cause execution of the modified instruction by the computer application.

14. The computing device of claim 13, wherein, to cause execution of the modified instruction, the processor device is further to:
transmit the modified instruction to the computer application.

15. The computing device of claim 13, wherein, to determine that the request satisfies the instructional credential, the processor device is further to determine that the computing device comprises an authorization credential configured to allow modification of the instruction.

16. The computing device of claim 13, wherein the interference event comprises an insufficient amount of memory resources available to at least one of: the computing device, the computer application, the LLM, a second computing device having memory resources at least partially dependent on an amount of resources allocated to the computer application.

17. The computing device of claim 13, wherein, to determine that the instruction comprises the interference command, the processor device is further to determine that the instruction would allocate processing resources away from or toward the computer application.

18. The computing device of claim 17, wherein the interference event comprises an amount of processing resources allocated to the computer application that are outside a threshold range of processing resources.

19. The computing device of claim 13, wherein the processor device is further to:
generate, based on removing the interference command, an alert comprising an indication that the instruction was modified.

20. A non-transitory computer-readable storage medium that includes executable instructions to cause a processor device to:
obtain a request comprising a query for a large language model (LLM) to generate an instruction for execution by a computer application;
determine that the request satisfies an instructional credential that verifies whether the instruction is to be executed by the computer application;
transmit, based on determining that the request satisfies the instructional credential, the query to the LLM;
receive, from the LLM, an output comprising the instruction for the computer application;
determine that the instruction further comprises an interference command, wherein the interference command, in response to execution by the computer application, would result in an interference event, wherein, to determine that the instruction further comprises the interference command, the executable instructions further cause the processor device to:
evaluate the instruction in view of an operational constraint for the computer application; and
identify the interference command within the instruction based on evaluating the instruction in view of the operational constraint;
modify, based on determining that the instruction comprises the interference command, the instruction by removing the interference command to generate a modified instruction; and
cause execution of the modified instruction by the computer application.
